(19) United States
(12) Patent Application Publication
(10) Pub. No.: US 2026/0042506 A1
(43) Pub. Date: Feb. 12, 2026

(54) ELECTRICAL PEDAL ASSIST BICYCLE POWERTRAIN

(71) Applicant: DRIVEN TECHNOLOGIES, INC., Boulder, CO (US)

(72) Inventors: Jason Smith, Boulder, CO (US); Cameron Frazer, Boulder, CO (US); Ryan Norris, Boulder, CA (US)

(21) Appl. No.: 19/102,018

(22) PCT Filed: Aug. 8, 2023
(86) PCT No.: PCT/US2023/029732

§ 371 Date: Feb. 7, 2025

Related U.S. Application Data
(60) Provisional application No. 63/395,999, filed on Aug. 8, 2022.

(30) Foreign Application Priority Data
Jan. 25, 2023 (DK) PA202300065

(51) Int. Cl. B62M 6/55; B62M 11/14; B62M 11/18

(52) U.S. Cl. CPC B62M 6/55; B62M 11/145; B62M 11/18

(57) ABSTRACT

A human-electric hybrid powertrain with a continuously variable transmission achieved with the use of a bevel planetary gearset. Two electric motors are utilized to produce a hybrid powertrain with either a driveshaft, chain, or belt driveline. The electric motors combine to produce an infinitely variable range of gear ratios and power assistance to the operator.

### CROSS REFERENCE TO RELATED PATENT APPLICATIONS

This application is a U.S. National Phase Application of International Application No. PCT/US2023/029732, filed Aug. 8, 2023, which claims priority to U.S. Provisional Application No. U.S. 63/395,999, filed on 8 Aug. 2022, and to Danish Patent Application No. PA 2023 00065, filed on 25 Jan. 2023, all of which are hereby incorporated by reference in their entirety.

### FIELD OF THE INVENTION

The present invention relates generally to an electric pedal assist bicycle transmission utilizing a continuously variable transmission.

### BACKGROUND

An electric pedal assist bicycle powertrain is a type of hybrid drive where power provided by an electric motor and power provided by a human are combined in an additive fashion to mobilize a bicycle. Numerous types of electric pedal assist bicycle powertrains exist, but generally, traditional electric pedal assist bicycle powertrains are complicated due to the combination of new and legacy products to achieve a multispeed powertrain. An example of such a combined product is the use of a mid-drive electric motor with a derailleur and chain transmission. Other popular examples found in prior art include U.S. Pat. No. 10,137,954, U.S. Pat. No. 9,302,734, DE10,2018,130,377, US20,150,011,346, U.S. Pat. No. 9,777,774, and U.S. Pat. No. 10,773,771. The motors in these types of drives may utilize planetary gearsets to step the speed of the motor down to match rider cadence. Examples of these drives include U.S. Pat. No. 8,985,254 and U.S. Pat. No. 8,652,000. DE 102021212131 describes an electric pedal assist bicycle powertrain with a continuously variable transmission and two electrical motors both engaging a bicycle chain via one or more planetary gearsets, and a crank shaft connected via a one-way clutch. DE 102018212584 discloses a similar powertrain, and also a controller to control torque or speed of the motors based on signals received by cable or wireless. The above-mentioned planetary gearsets are flat-planetary arrangements which provide non-compact placement of the two motors and cause a gear ratio change between the sun gear and ring gear. DE102019006708A1 and US2015/300472A1 also disclose bicycle drivetrains with two motors as described above, and which further include embodiments with bevel gears.

### SUMMARY

Described herein is an electric pedal assist powertrain for a bicycle. More specifically, the embodiments provided herein are continuously variable transmissions that can utilize either a driveshaft, belt, or a chain driveline. The continuously variable nature of the transmission is achieved through a bevel planetary gear train. The embodiments described herein may be used in any human powered vehicle that can utilize power assistance from an electric motor. The most common of those applicable vehicles is a bicycle for either on or off-road use. The powertrains described herein beneficially may be compact, high power, high efficiency continuous variable transmissions. Contrary to the above-mentioned flat-planetary arrangements, the bevel planetary gear train of the present invention provides for more compact placement of the motors. Further, the bevel planetary gear train of the present invention enables a unity ratio between the bevel sun gear and the bevel ring gear.

In some embodiments the gears within the bevel planetary gear train receive power from electric motors or from the rider depending on the driveline choice of either a driveshaft or a chain or belt. The output direction of the bevel planetary gear train can be the same or opposite for each of these embodiments. In all embodiments the speeds of the sun gear, planet carrier, and ring gear are controlled either by an electronic control system or the rider through their application of power at the input of the bevel planetary gear train.

According to certain embodiments the bevel gears within the bevel planetary gear train and the bevel gears of the driveshaft may be of differing sizes to accommodate different applications. For example, on-road bicycles travel at faster speeds than off road bicycles therefore each of these applications require a different range of and absolute values of gear ratios.

In some embodiments that require high efficiency, gears with rolling elements like lantern gears are utilized. This is possible because unlike in a standard planetary gear train where the sizes of the planet gears affect the gear ratio, this is not the case for a bevel planetary gear train.

In various embodiments the maximum speed of the vehicle is controlled by switching one of the motors into a regenerative brake to adhere to regulations surrounding the speeds of electric vehicles. This switching is required to maintain the same gear ratio being provided by the other motor.

Various other benefits and advantages may be realized with the devices and methods provided herein, and the aforementioned advantages should not be considered limiting.

In an aspect, a human-electric hybrid powertrain has a continuously variable transmission comprising a planetary gear train having a sun gear, a planet carrier and a ring gear rotatably mounted to an input crank shaft and a plurality of planet gears rotatably mounted to the planet carrier. A first and second motor engage the planetary gear train and are configured to provide drive power or speed control, wherein a one way clutch rotatably connects the crank shaft to the planetary gear train. A controller connected to the first and second motors is configured to maintain power and speed ratio and to receive wired or wireless signals from an operator interface device to modify either power or speed ratio. The planetary gear train is advantageously a bevel planetary gear train, where the sun gear is a bevel sun, the ring gear is a bevel ring gear, and the plurality of planet gears are a plurality of bevel planet gears. The human-electric hybrid powertrain may transfer power to a driving wheel either by a bevel output gear being configured to mesh with a driveshaft connected to the driving wheel, or by a chain or belt being configured to transfer power to the driving wheel. The second motor engages the bevel ring gear.

The human-electric hybrid powertrain may be arranged in one of at least two different configurations with respect the first motor. In a first possible configuration, the first motor may engage with the planet carrier and the one way clutch be rotatably connecting the crank shaft to the bevel sun. In a second possible configuration, the first motor may engage with the bevel sun and the one way clutch be rotatably connecting the crank shaft to the planet carrier.

The transfer of power from the human-electric hybrid powertrain to the driving wheel may also be arranged in one of at least four different configurations. In a first power transfer configuration, the bevel ring gear may include a first gear face for engaging the planet gears and a second gear face arranged as the bevel output gear for engaging a bevel gear drive of the driveshaft connected to the driving wheel. The ring gear with two gear faces may be machined as one pieces or combined from two bevel gears fixed to each other. In a second power transfer configuration, the bevel ring gear may comprise sprocket teeth or engage a chain ring with sprocket teeth, for example by having the chain ring mounted on the ring gear, for engaging the chain or belt configured to transfer power to the driving wheel. In a third power transfer configuration, a secondary planet gearset may be provided to connect the bevel ring gear with the bevel output gear. In a fourth power transfer configuration, a secondary planet gearset may be provided to connect the bevel ring gear with the chain or belt. Any of the four power transfer configurations may be combined with any of the two first motor configurations.

The sun gear and the bevel ring gear may each be on the crank shaft, and the at least one planet gear may be engaged with both the sun gear and the bevel ring gear.

The human-electric hybrid powertrain may advantageously be mounted on a bicycle, preferably together with a battery, such as to provide a so-called e-bike or electric bike.

In an aspect, a bicycle comprises the human-electric hybrid powertrain according to any of the above configurations. The bicycle may advantageously comprise a battery to power the first and second motors, and preferably the controller.

### BRIEF DESCRIPTION OF THE DRAWINGS

The principles of the embodiments described herein show the structure and operation of several examples used to illustrate the disclosure. It should be understood that the drawings are diagrammatic and schematic representations of such example embodiments and, accordingly, are not limiting the scope of the present invention, nor are the drawings necessarily drawn to scale.

FIG. 1 illustrates a typical bicycle frame and the location of electric components for rider assistance.

FIG. 2 illustrates an electric pedal assist powertrain consisting of motors, bevel gears and a driveshaft.

FIG. 3 illustrates another perspective of an electric pedal assist powertrain to highlight internal details.

FIG. 4 illustrates the bevel planetary gearset which allows for a continuously variable transmission.

FIGS. 5a-b illustrate alternate embodiments of motors and their corresponding drives for an electric pedal assist powertrain.

FIG. 6 illustrates another embodiment of an electric pedal assist powertrain where the control motor and planet carrier have alternate power sources.

FIG. 7 illustrates a variation of the embodiment depicted in FIG. 6 for a chain driveline.

### DETAILED DESCRIPTION

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

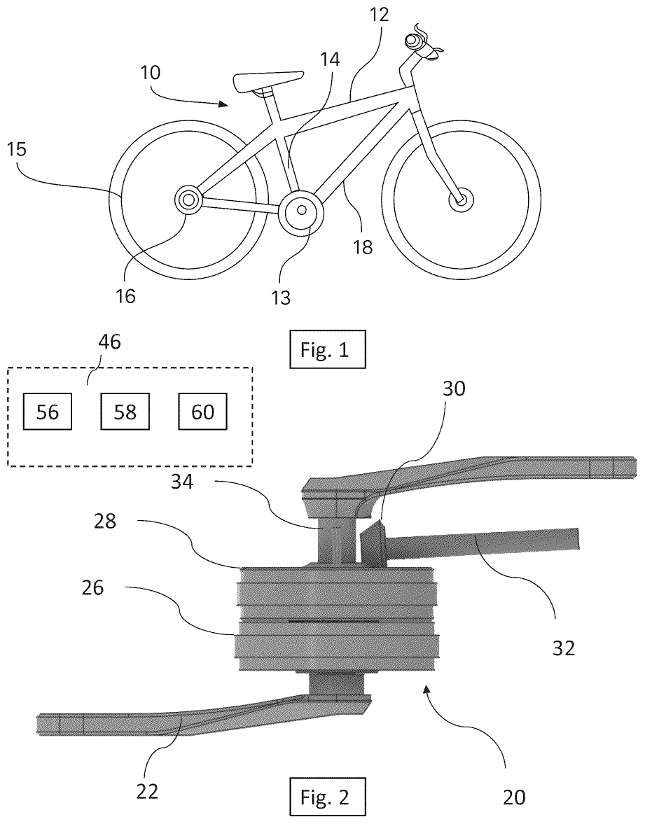

FIG. 1 illustrates an electric pedal assist bicycle 10 (hereinafter “bicycle 10”) that generally includes a frame 12 with a bottom bracket 13, seat tube 14, down tube 18, and rear hub 16 with a driving wheel 15. An assistance motor (not illustrated in FIG. 1 for simplicity of the figure) may be provided in or on various portions of the frame 12, such as but not limited to the bottom bracket 13 or rear hub 16. The electric pedal assist bicycle 10 may also have gear change systems at various locations such as but not limited to the bottom bracket 13 or rear hub 16. Batteries and auxiliary electronics (not illustrated) may be located within the down tube 18 and/or other locations as desired.

FIGS. 2-4 illustrate an example of an electric pedal assist powertrain 20 (hereinafter “hybrid powertrain 20”) for a bicycle such as the bicycle 10 according to embodiments. The hybrid powertrain 20 generally includes a bicycle crank 22, a bevel planetary gearset 24, a first motor 26, optionally a second motor 28, a bevel gear drive 30, and a driveshaft 32. A control system 46 may be used with the hybrid powertrain 20 in certain embodiments and as discussed in detail below. The hybrid powertrain 20 delivers power to the rear hub 16 and driving wheel 15 via the driveshaft 32.

The bicycle crank 22 includes a shaft 34. Pedals and/or other features or devices may be supported on the bicycle crank 22 for a rider to engage and thereby provide human power into the hybrid powertrain 20 as desired. The particular bicycle crank 22 illustrated should not be considered limiting.

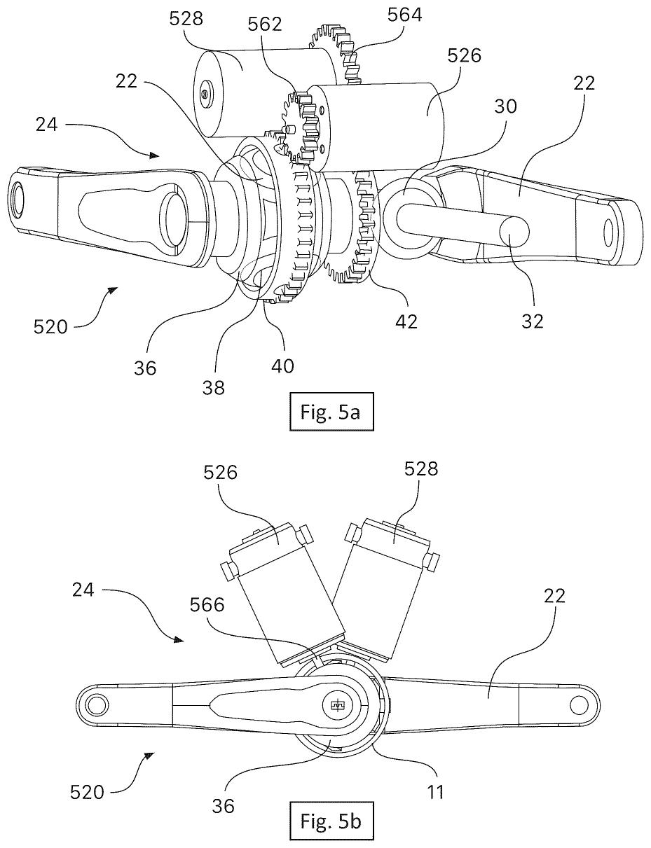

The first motor 26 and the second motor 28 may be various types of framed or frameless motors as desired. In FIGS. 2-4, the motors 26, 28 illustrated are frameless motors. FIGS. 5a-b, discussed in detail below, illustrate examples of framed motors. In certain embodiments, the second motor 28 is a power motor for providing a steady state of output power to the system, and the first motor 26 may be a control motor providing speed matching between the second (power) motor 28 and the bicycle crank 22 so the rider can maintain a comfortable cadence. As non-limiting examples of motors, in FIGS. 2-4, the first motor 26 may be a direct drive brushless DC torque motor with a position feedback device, thereby making it a type of servo motor, and the second motor 28 may be a direct drive brushless DC torque motor. In another embodiment, the second motor 28 may be converted into a servo motor with a position feedback device. Examples of position feedback devices for direct drive motors include, but are not limited to, optical ring encoders, ring Hall-effect encoders, inductive encoders, combinations thereof, and/or other types of position feedback devices as desired. In further embodiments, the motors 26, 28 are brushed and may or may not be considered frameless.

The control system 46 includes a controller 56 and optionally includes an interface 58 and/or one or more sensors 60. The components of the control system 46 may be provided at various locations on the bicycle 10 as desired. The controller 56 is operatively coupled to the motors 26, 28, and may be various types of controllers as desired. As a non-limiting example, the controller 56 may include a processor and/or memory, although it need not in other embodiments, and other types of control devices for controlling the motors 26, 28 may be utilized.

When included, the interface 58 may be on the controller 56 itself or may be a component separate from the controller 56. The interface 58 may be various types of physical and/or virtual interfaces as desired for receiving an input from the rider. The interface 58 may be provided at various locations as desired, and in one non-limiting example may be provided on or proximate to handlebars of the bicycle 10. In certain embodiments, the controller 56 is operatively coupled to the motors 26, 28, and may control one or both motors 26, 28 based on the input from the rider. In various embodiments, the controller 56 receives wired or wireless signals from the interface 58 to modify characteristics of the motors 26, 28, such as but not limited to power and/or speed ratio.

Optionally, the control system 46 includes one or more sensors 60, and the controller 56 may receive information from the sensors 60 via wired or wireless communication. In certain embodiments, the controller 56 may control one or both motors 26, 28 based on information from the sensors (alone or in combination with input from the rider). Non-limiting examples of sensors 60 include but are not limited to strain gauges, accelerometers, gyroscopes, combinations thereof, and/or other types of sensors for detecting or measuring other information related or relevant to operation of the hybrid powertrain 20.

In certain embodiments, the hybrid powertrain 20 with the control system 46 may be capable of discrete gear ratios by utilizing software in combination with the onboard sensors. These gear ratios can be customized by the rider prior to and/or during the use of the hybrid powertrain 20 using the interface 58. These gear ratios may be selectable by the rider on the fly utilizing the interface 58. The continuously variable transmission also provides the ability for the powertrain 20 to be automatic in changing gear ratios to allow the rider to maintain a steady cadence regardless of the speed of the bicycle 10.

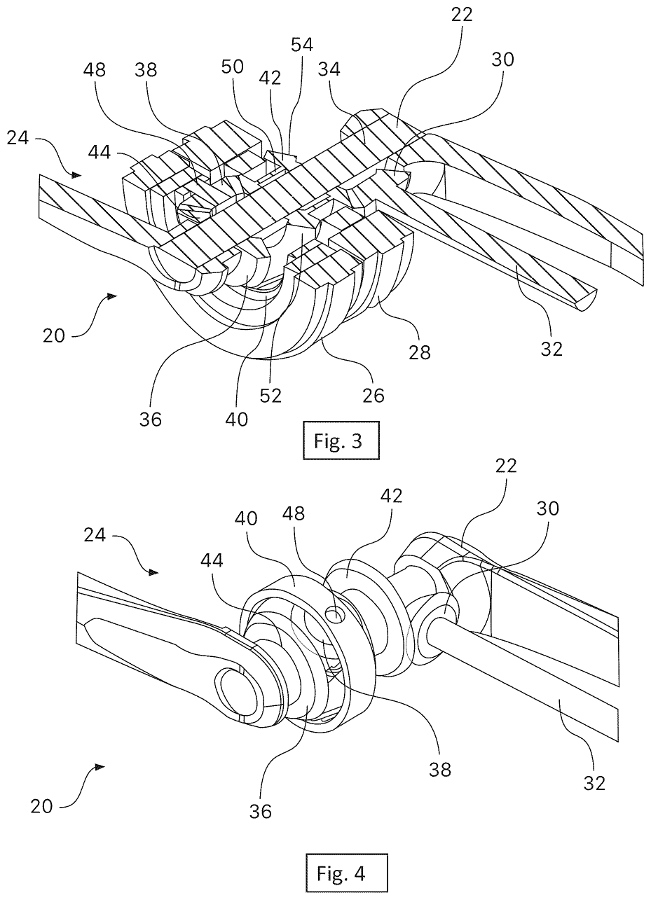

As best illustrated in FIGS. 3 and 4, the bevel planetary gearset 24 generally includes a bevel sun gear 36, one or more bevel planet gears 38, a planet carrier 40, and a bevel ring gear 42.

The bevel sun gear 36 may be centered to the bicycle crank 22 (e.g., on the shaft 34). In certain embodiments, a clutch 44 such as but not limited to a bearing (best illustrated in FIG. 3) acts as the mechanical linkage between the bevel sun gear 36 and the shaft 34. In one non-limiting embodiment, the clutch 44 is a one-way bearing clutch (e.g., configured to transmit torque between the sun gear 36 and the shaft 34 in one direction and free motion in the opposite direction), although in other embodiments, other types of clutches may be utilized as desired. In various embodiments, the clutch 44 may beneficially disconnect the rider/bicycle crank 22 from the bevel planetary gearset 24 to protect the rider in various situations. As a non-limiting example, the clutch 44 may disconnect the rider/bicycle crank 22 in the event the motors 26 and/or 28 cause the crank 22 to rotate faster than the rider cadence. Additionally, or alternatively, the clutch 44 beneficially may prevent the rider from back-driving the hybrid powertrain 20, which may confuse and/or otherwise cause issues with the control system 46.

The planet gears 38 of the bevel planetary gearset 24 are connected to the planet carrier 40 via mechanisms such as but not limited to pins 48. In the embodiment illustrated there are three planet gears 38. However, the number of planet gears 38 should not be limiting, and in other embodiments, any number of planet gears 38 may be used as desired, including less than three planet gears 38 or more than three planet gears 38. In various embodiments, the first motor 26 is attached and/or engaged with the planet carrier 40 (optionally affixed rigidly), although it need not be in other embodiments.

As best illustrated in FIGS. 3 and 4, similar to the bevel sun gear 36, the bevel ring gear 42 is connected to the crank 22. In certain embodiments, a bearing 50 (best illustrated in FIG. 3) or other suitable devices or mechanisms connects the bevel ring gear 42 with the shaft 34. In one non-limiting embodiment, the bearing 50 is a ball bearing, although it need not be in other embodiments. The bevel ring gear 42 includes a first gear face 52 for engaging the planet gears 38 and a second gear face 54 for engaging the bevel gear drive 30. In certain embodiments, the bevel ring gear 42 is connected to the driveshaft 32 via the bevel gear drive 30, and as best illustrated in FIG. 3, the bevel gear drive 30 engages the second gear face 54 of the bevel ring gear 42. In use, the planet carrier 40 rotates in the opposite direction of the sun gear 36, but in the same direction as the bevel ring gear 42. Such rotation achieves the rotational direction of the driveshaft 32 required for the rear wheel 15 to produce forward locomotion. The second motor 28 may be attached and/or engaged with the bevel ring gear 42.

The control motor 26 modifies the bevel planetary gearset 24 from a single speed gear train into a continuously variable transmission. The power motor 28 allows a steady state of output power to be provided to the rider. The control motor 26 provides speed matching between the crank 22 and power motor 28 so the rider can maintain a comfortable cadence. If the speed of the control motor 26 is increased, the amount of assistance from the control motor increases, and the power motor 28 may provide the difference.

The hybrid powertrain 20 with the bevel planetary gearset 24 provides an opportunity to optimize the gear ratio between the input and output of the driveshaft 32 for a bicycle. As one non-limiting example, the hybrid powertrain 20 may comfortably fit in and/or otherwise be supported at the bottom bracket 13 area of the bicycle 10, which has limited available space (e.g., due to the maximum comfortable spacing between the rider's feet). The hybrid powertrain 20 with the bevel planetary gearset 24 also allows for higher transmission ratios achievable in smaller spaces compared to traditional powertrains.

Another advantage of the hybrid powertrain 20 with the bevel planetary gearset 24 is the ability to significantly increase the size of the planet gears 38. The planet gears 38 in the powertrain 20 span a distance to mesh with two external gears (e.g., the sun gear 36 and the bevel gear ring 42), unlike a conventional planetary gear trains where the planet gears are confined to an internal gear, thereby reducing the maximum size of traditional planet gears. The increased size of the planet gears 38 allows for greater torque capacity, which may be advantageous when designing electric assist bicycles where the motors 26, 28 can produce more torque to the rider, and the rider is thereby capable of producing torque equivalent to an automobile (although it need not). The increased size of the planet gears 38 also allows for non-conventional tooth architectures to be utilized in other embodiments. As non-limiting examples, the bevel planet gears 38 could be lantern bevel gears and/or similar rolling elements to increase the efficiency of the transmission.

In some embodiments, and as best illustrated in FIG. 4, the sun gear 36 optionally is a same size (e.g., same sized outer diameter) as the bevel ring gear 42. It should be evident that this layout would not be possible with a standard planetary gear train. In embodiments where the sun gear 36 is a same size as the bevel ring gear 42, if the control motor 26 was to hold the carrier stationary, the gear ratio of the embodiment illustrated is 1:1.

In other embodiments, the sun gear 36 and the bevel ring gear 42 may be different sizes. Utilizing a sun gear 36 and bevel ring gear 42 of differing sizes allows the control motor 26 and power motor 28 to be balanced in terms of their power assistance leading to motors of similar size and specification. As one non-limiting example, the sun gear 36 is larger than the bevel ring gear 42. Such embodiments may provide a step up in speed when the planet carrier 40 is held stationary. An arrangement where the sun gear 36 is larger than the bevel ring gear 42 may allow for a smaller control motor 26 to achieve the same output speed. Such an arrangement in turn would lower the torque contribution of the control motor 26 which may be compensated for by the power motor 28. In another non-limiting example, the sun gear 36 is smaller than the bevel ring gear 42.

As another non-limiting example, the hybrid powertrain 20 with the bevel planetary gearset 24 provides a continuously variable transmission with an infinite number of gear ratios within a fixed range. As mentioned, the hybrid powertrain 20 is capable of discrete gear ratios by utilizing software in combination with the onboard sensors, and such gear ratios can be customized by the user and/or selected as desired. The continuously variable transmission also provides the ability for the hybrid powertrain 20 to be automatic in changing gear ratios to allow the rider to maintain a steady cadence regardless of the speed of the bicycle.

There are many international, national, and regional regulations surrounding the speed electric assist bicycles are allowed to transit at. In such cases, the hybrid powertrain 20 described herein may achieve a wide range of gear ratios without exceeding the speed limits imposed by regulations surrounding electric assist bicycles. As non-limiting examples, the power motor 28 of the hybrid powertrain 20 may not only provide additional assistance, but when the control motor 26 is providing too much power to achieve a certain gear ratio (and therefore a transit speed that is too high), the power motor 28 may be used as a regenerative motor. In such an example, utilizing the power motor 28 as a regenerative motor allows the hybrid powertrain 20 to achieve a wide range of gear ratios without exceeding the speed limits imposed by regulations surrounding electric assist bicycles.

In yet another embodiment of the powertrain 20, the power motor 28 is not utilized (either by deactivation, complete omission, disengagement, etc.). In embodiments where the power motor 28 is not utilized, the hybrid powertrain may create a single speed electric assist bicycle. In such an embodiment, as the rider speed increases, the amount of assistance increases. This embodiment could be utilized in a children's bicycle or commuter bicycle and/or as otherwise desired.

As additional non-limiting examples, the bevel planetary gearset 24 within the hybrid powertrain 20 allows the additive torque of the power motor 28 and the rider input via the crank 22 to be delivered to the driveshaft 32. In certain embodiments, the control motor 26 provides speed matching between the crank 22 and power motor 28 so the rider can maintain a comfortable cadence.

FIGS. 5a and 5b illustrate additional embodiments of a hybrid powertrain 520 that is substantially similar to the hybrid powertrain 20 except that the hybrid powertrain 520 includes the motors 526 and 528. In this embodiment, the motors 526, 528 are framed motors and are used in place of frameless motors 26, 28. As best illustrated in FIG. 5a, spur gears 562, 564 564 are used to transmit the motor power to the planet carrier 40 and bevel ring gear 42, respectively. As best illustrated in FIG. 5b, replacing the spur gears 562, 564 with bevel gears 566 may allow a different orientation of the motors 526, 528. In further embodiments, chains and sprockets, belts and pulleys, and/or other features or mechanisms are used to transmit motor power to the planet carrier 40 and/or the bevel ring gear 42 are used. Framed motors might be used for either the control motor 526, power motor 528, or both. The advantage these embodiments present is for the use of motors of lower torque and power to achieve the same bicycle speeds. The embodiments with framed motors may be combined with any of the configurations described herein relating to frameless motors, in particular with respect to configurations of power transfer from the bevel gearset to the driving wheel being driveshaft, chain or belt, and/or with respect to where the first motor is engaged being the planet carrier or the sun gear, and/or whether or not a secondary planetary gearset is provided between the bevel ring gear and the power transfer to the driving wheel.

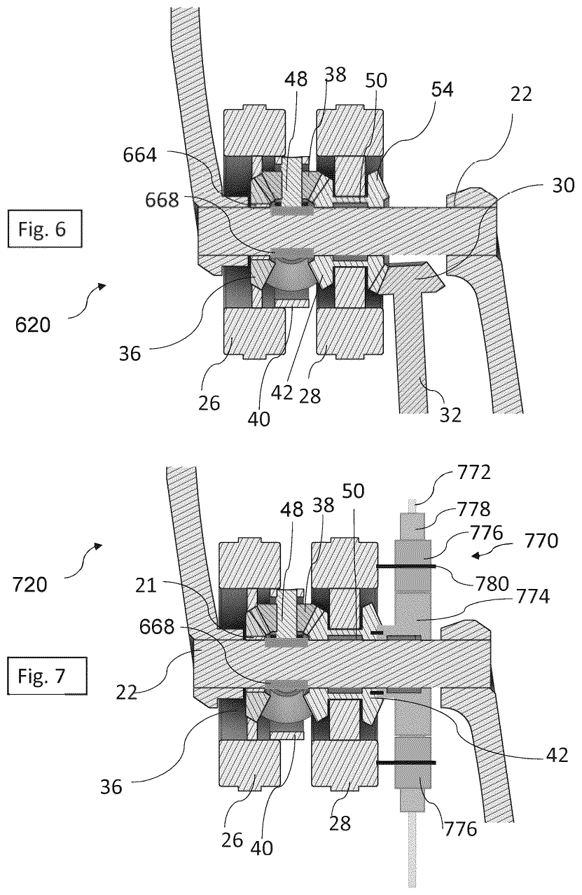

FIG. 6 illustrates another embodiment of a hybrid powertrain 620 according to embodiments. The hybrid powertrain 620 is substantially similar to the hybrid powertrain 20 except that the control motor 26 is rigidly affixed to the sun gear 36 rather than the planet carrier 40 as in the hybrid powertrain 20. In this embodiment, a spindle bearing 664 may isolate the sun gear 36 from the crank 22 input provided by the rider. In the hybrid powertrain 620, the crank 22 transmits torque to the planet pins 48 and planet carrier 40 through a unidirectional clutch 668 such as, but not limited to, a one way bearing or ratchet. The power motor 28 and bevel ring gear 42 arrangement is unchanged compared to the hybrid powertrain 20, and therefore the direction of the bevel ring gear 42 is determined by the direction of the sun gear 36. In the hybrid powertrain 620, the direction of the sun gear 36 also determines the magnitude of gear ratio at a given power. In such embodiments, a second planetary stage may be utilized to achieve the direction of the bevel ring gear 42 and gear ratio required. The embodiments with the first motor engaging the sun gear may be combined with any of the configurations described herein relating to the first motor engaging the planet carrier, in particular with respect to configurations of power transfer from the bevel gearset to the driving wheel being driveshaft, chain or belt, and/or with respect to the motors being frameless or framed, and/or whether or not a secondary planetary gearset is provided between the bevel ring gear and the power transfer to the driving wheel.

FIG. 7 illustrates a further embodiment of a hybrid powertrain 720 according to embodiments. The hybrid powertrain 720 is substantially similar to the hybrid powertrains 20, 520, 620 except that the hybrid powertrain includes a direction change planetary gearset 770. The direction change planetary gearset 770 may be particularly advantageous when utilizing a chain 772 or belt driveline, or in aiding an embodiment for a driveshaft 32 mated with a bevel ring gear 42 rotating in the wrong direction. The direction change planetary gearset 770 may also be referred to as a secondary planetary gearset and may in addition to changing the direction also provide a gear ratio change. The direction change planetary gearset 770 includes of a sun gear 774, one or more planet gears 776, a planet carrier 780, and a ring gear 778. In the case of a chain 772 or belt driveline, the sprocket teeth could be machined directly into the exterior of the secondary gearset ring gear 778. In the embodiment with the hybrid powertrain 720, to get the direction change, the planet carrier 780 of the planet gears 776 may be rigidly affixed to a static element of the powertrain 720, such as but not limited to the case of the power motor 28 and/or the bottom bracket 13 of the frame 12. The embodiments with the secondary planetary gearset, may be combined with any of the configurations described herein not having a secondary gearset, in particular with respect to configurations of power transfer from the bevel gearset to the driving wheel being driveshaft, chain or belt, and/or with respect to the motors being frameless or framed, and/or with respect to the first motor engaging the bevel sun gear or the planet carrier.

The power transfer using chain 772 or belt driveline may also be implemented in the embodiments not having a secondary planetary gearset. For example, in the embodiments of FIGS. 4-6, sprocket teeth for a chain 772 or belt could be machined directly into the exterior of the bevel ring gear 42, or a chain ring be mounted to the bevel ring gear 42.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

Various aspects of the invention may further be exemplified by the following illustrations:
Illustration 1: A human-electric hybrid powertrain with a continuously variable transmission comprising:
   a bevel planetary gear train having a planet carrier, a bevel sun and a bevel ring gear that is rotatably mounted to an input crank shaft;
   a plurality of bevel planet gears rotatably mounted to a crank shaft;
   a bevel output gear meshing with a driveshaft connected to the driving wheel
   a first and second motor engaged with the planet carrier and bevel ring gear, respectively, providing drive power or speed control
   a one way clutch rotatably connecting the crank shaft to the sun gear
   a controller connected to said first and second motors to maintain power and speed ratio
   wherein said controller receives wired or wireless signals from the operator interface device to modify either power or speed ratio.
Illustration 2: The human-electric hybrid powertrain of Illustration 1 wherein the first motor is engaged with the bevel sun or the planet carrier.
Illustration 3: The human-electric hybrid powertrain of Illustration 1 wherein a one way clutch is rotatably connecting the crank to the planet carrier.
Illustration 4: The human-electric hybrid powertrain of Illustration 1 wherein a secondary planet gearset connects the bevel ring gear with the output.
Illustration 5: The human-electric hybrid powertrain of Illustration 1 wherein a chain or belt is utilized to transfer power to the driving wheel.
Illustration 6: A hybrid powertrain comprising:
   a drive shaft;
   a bevel planetary gearset comprising a bevel sun gear, at least one bevel planet gear, a planet carrier, and a bevel ring gear, wherein the sun gear and the bevel gear ring are each on the drive shaft, and wherein the at least one planet gear is engaged with both the sun gear and the bevel gear ring; and
   a first motor and a second motor connected to the bevel planetary gearset.
Illustration 7: The hybrid powertrain of Illustration 6, wherein the first motor is affixed to the bevel sun gear or the planet carrier.
Illustration 8: The hybrid powertrain of Illustration 6, wherein the second motor is connected to the bevel ring gear.
Illustration 9: The hybrid powertrain of Illustration 6, further comprising a one-way clutch connecting the drive shaft with the bevel sun gear.
Illustration 10: An electric pedal assist powertrain comprising a bevel planetary gearset.
Illustration 11: An electric pedal assist powertrain comprising a crank, an electric motor, and a bevel planetary gearset configured to receive power from the crank and/or the electric motor.
Illustration 12: An electric pedal assist powertrain comprising a bevel planetary gearset comprising a sun gear, a planet carrier, and a ring gear, and wherein speeds of the sun gear, the planet carrier, and the ring gear are controlled either by an electronic control system or the rider through their application of power at an input of the bevel planetary gearset.
Illustration 13: An electric pedal assist powertrain comprising a bevel planetary gearset comprising a sun gear, a planet carrier, and a ring gear, wherein a size of the sun gear is different from a size of the ring gear.
Illustration 14: An electric pedal assist powertrain comprising a bevel planetary gearset comprising a sun gear, a planet carrier, and a ring gear, wherein a size of the sun gear is the same as a size of the ring gear.
Illustration 15: An electric pedal assist powertrain for a human-powered vehicle comprising a bevel planetary gearset, a first motor, and a second motor, wherein a maximum speed of the vehicle is controlled by switching one of the motors into a regenerative brake to adhere to regulations surrounding the speeds of electric vehicles.
Illustration 16: An electric pedal assist powertrain, wherein the powertrain is a continuously variable transmission.
Illustration 17: A bicycle comprising the powertrain of any preceding illustrations.
Illustration 18: A human-powered vehicle that can utilize power assistance from an electric motor comprising the powertrain of any preceding illustrations.

### REFERENCE NUMBERS

10 Bicycle
12 Frame
13 Bottom bracket
14 Seat tube
15 Driving wheel
16 Rear hub
18 Down tube
20 Hybrid powertrain
22 Crank
24 Bevel planetary gearset
26 First motor
28 Second motor
30 Bevel gear drive of driveshaft 32
32 Driveshaft
34 Crank shaft of crank 22
36 Bevel sun gear of gearset 24
38 Bevel planetary gears of gearset 24
40 Planet carrier of gearset 24
42 Bevel ring gear of gearset 24
44 Clutch
46 Control system
48 Pins connecting planets 38 to carrier 40
50 Bearing for ring gear 42
52 First gear face of ring gear 42
54 Second gear face of ring gear 42
56 Controller
58 Interface
60 Sensors
520 Hybrid powertrain
526 First framed motor
528 Second framed motor
562, 564 Spur gears
566 Bevel gears
620 Hybrid powertrain
664 Spindle bearing for sun gear 36
668 Unidirectional clutch
720 Hybrid powertrain
770 Direction change secondary planetary gearset
772 Chain driveline
774 Sun gear for secondary planetary gearset
776 Planet gears for secondary planetary gearset 770
778 Ring gear for secondary planetary gearset 770
780 Planet carrier for secondary planetary gearset 770

What is claimed is:

1. A human-electric hybrid powertrain with a continuously variable transmission, the human-electric hybrid powertrain comprising:
a planetary gear train having:
a sun gear, a planet carrier, and a ring gear rotatably mounted to an input crank shaft, and
a plurality of planet gears rotatably mounted to the planet carrier;
a first motor and second motor, engaging the planetary gear train and being configured to provide drive power or speed control, wherein a one way clutch rotatably connects the input crank shaft to the planetary gear train; and
a controller connected to said first and second motors, the controller being configured to maintain power and speed ratio and to receive wired or wireless signals from an operator interface device to modify either the power or the speed ratio,
wherein the planetary gear train is a bevel planetary gear train, the sun gear is a bevel sun and the ring gear is a bevel ring gear,
wherein the plurality of planet gears are a plurality of bevel planet gears,
wherein the human-electric hybrid powertrain further comprises one of:
a bevel output gear configured to mesh with a driveshaft connected to a driving wheel, or
a chain or belt configured to transfer power to a driving wheel,
wherein the second motor engaged with the bevel ring gear, and
wherein the first motor is engaged with the bevel sun, and the one way clutch is rotatably connecting the input crank shaft to the planet carrier.

2. The human-electric hybrid powertrain of claim 1, further comprising the bevel output gear, and
wherein the bevel ring gear includes:
a first gear face for engaging the planet gears, and
a second gear face arranged as the bevel output gear for engaging a bevel gear drive of the driveshaft connected to the driving wheel.

3. The human-electric hybrid powertrain of claim 1, the human-electric hybrid powertrain further comprises the chain or the belt, and
wherein the bevel ring gear:
includes sprocket teeth, or
engages a chain ring with sprocket teeth for engaging the chain or the belt.

4. The human-electric hybrid powertrain of claim 1, comprising a secondary planet gearset connecting the bevel ring gear with the one of the:
bevel output gear, or
the chain or the belt.

5. The human-electric hybrid powertrain of claim 1, wherein the bevel sun gear and the bevel ring gear are each on the crank shaft, and
wherein the plurality of planet gears is engaged with both the bevel sun gear and the bevel ring gear.

6. The human-electric hybrid powertrain of claim 1, wherein the human-electric hybrid powertrain is mounted on a bicycle.

7. A bicycle comprising:
a human-electric hybrid powertrain with a continuously variable transmission, the human-electric hybrid powertrain including:
a planetary gear train having:
a sun gear, a planet carrier, and a ring gear rotatably mounted to an input crank shaft, and
a plurality of planet gears rotatably mounted to the planet carrier, and
a first motor and a second motor engaging the planetary gear train and being configured to provide drive power or speed control, wherein a one way clutch rotatably connects the input crank shaft to the planetary gear train; and
a controller connected to the first motor and the second motor, the controller being configured to maintain power and speed ratio and to receive wired or wireless signals from an operator interface device to modify either the power or the speed ratio,
wherein the planetary gear train is a bevel planetary gear train, the sun gear is a bevel sun gear, and the ring gear is a bevel ring gear,
wherein the plurality of planet gears is a plurality of bevel planet gears,
wherein the human-electric hybrid powertrain further comprises one of:
a bevel output gear configured to mesh with a driveshaft connected to a driving wheel, or
a chain or belt configured to transfer power to a driving wheel,
wherein the second motor is engaged with the bevel ring gear, and
wherein the first motor is engaged with the bevel sun gear, and the one way clutch is rotatably connecting the input crank shaft to the planet carrier.

8. The bicycle of claim 7, further comprising a battery arranged to power the first motor and the second motor.

9. The bicycle of claim 7, further comprising a battery arranged to power the controller.

10. A human-electric hybrid powertrain with a continuously variable transmission, the human-electric hybrid powertrain comprising:
a planetary gear train having:
a sun gear, a planet carrier, and a ring gear rotatably mounted to an input crank shaft;
a plurality of planet gears rotatably mounted to the planet carrier; and
a first motor and a second motor engaging the planetary gear train and being configured to provide drive power or speed control, wherein a one way clutch rotatably connects the crank shaft to the planetary gear train; and
a controller connected to the first motor and the second motor, the controller being configured to maintain power and speed ratio and to receive wired or wireless signals from an operator interface device to modify either the power or the speed ratio,
wherein the planetary gear train is a bevel planetary gear train, the sun gear is a bevel sun and the ring gear is a bevel ring gear,
wherein the plurality of planet gears is a plurality of bevel planet gears,
wherein the human-electric hybrid powertrain further comprises one of:
a bevel output gear being configured to mesh with a driveshaft connected to a driving wheel, or
a chain or belt being configured to transfer power to a driving wheel,
wherein the second motor is engaged with the bevel ring gear, and
wherein the first motor is engaged with the planet carrier, and the one way clutch is rotatably connecting the crank shaft to the bevel sun gear.

11. The human-electric hybrid powertrain of claim 10, the human-electric hybrid powertrain further comprises the bevel output gear, and
wherein the bevel ring gear includes:
a first gear face for engaging the planet gears, and
a second gear face arranged as said bevel output gear for engaging a bevel gear drive of the driveshaft connected to the driving wheel.

12. The human-electric hybrid powertrain of claim 10, the human-electric hybrid powertrain further comprises the chain or the belt, and
wherein the bevel ring gear:
includes sprocket teeth, or
engages a chain ring with sprocket teeth for engaging the chain or belt configured to transfer power to the driving wheel.

13. The human-electric hybrid powertrain of claim 10, further comprising a secondary planet gearset connecting the bevel ring gear with the one of:
the bevel output gear, or
the chain or the belt.

14. The human-electric hybrid powertrain of claim 10, wherein the bevel sun gear and the bevel ring gear are each on the crank shaft, and
wherein the plurality of planet gears is engaged with both the bevel sun gear and the bevel ring gear.

15. The human-electric hybrid powertrain of claim 10, wherein the human-electric hybrid powertrain is mounted on a bicycle.

16. The human-electric hybrid powertrain of claim 10, wherein the first motor and the second motor are powered by a battery.

17. The human-electric hybrid powertrain of claim 10, wherein the controller is powered by a battery.
